(19) United States
(12) Patent Application Publication
(10) Pub. No.: US 2011/0283286 A1
(43) Pub. Date: Nov. 17, 2011

(54) Methods and systems for dynamically adjusting performance states of a processor

(75) Inventors: Wuxian Wu, Round Rock, TX (US); Dirie N. Herzi, Round Rock, TX (US); Gregory N. Darnell, Georgetown, TX (US); Vijay Nijhawan, Austin, TX (US)

(73) Assignee: DELL PRODUCTS L.P., Round Rock, TX (US)

(21) Appl. No.: 12/800,192

(22) Filed: May 11, 2010

(51) Int. Cl. G06F 9/46

(52) U.S. Cl. 718/103; 718/102

(57) ABSTRACT

A method for dynamically adjusting performance states of a processor includes executing a workload associated with a workload mode and determining a primary thread among all processor threads executing the workload. The method also includes calculating and setting a performance state (P state) of the processor based on the workload mode.

### TECHNICAL FIELD

The present disclosure relates generally to the field of information handling systems, and, more specifically, to processor power management methods and systems.

### BACKGROUND

As the magnitude and use of information continues to increase, individuals and businesses seek additional ways to process and store information. One option available to users is an information handling system. An information handling system generally processes, compiles, stores, and/or communicates information or data for business, personal, or other purposes thereby allowing users to take advantage of the magnitude of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for such systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Power efficiency is a key aspect of performance for information handling systems (IHSs) ranging from small portable devices, such as laptops or PDAs to rack-mounted processor farms. Power efficiency may be determined both by hardware design and component choice, and software-based runtime power management techniques.

As the demand for greater performance at equivalent levels of power consumption increases, information handling system (IHS) manufacturers have attempted to develop power management systems which allow processor performance and power consumption levels to be modified while the IHS is operational. Typically, a target processor performance state may be inputted into the processor to achieve an optimal performance per power ratio. When the target processor performance state is greater than a processor performance state necessary to execute a concurrent processor workload, power may be wasted during the execution of the workload. On the other hand, when the target processor performance state is insufficient to execute the concurrent workload in a specified time, there may be a reduced performance per power ratio associated with the processor. Therefore, adjusting the target processor performance state in accordance with executing a concurrent processor workload may be necessary to achieve an optimal performance per power ratio.

In a conventional power management system, the basic input/output system (BIOS) may constantly monitor a current processor workload by its volume and further decide a proper target processor performance state. At any given time, processor workload may vary. Typically, the power management system may adjust processor (e.g., central processing unit (CPU)) performance accordingly and allow the processor workload to be executed at minimal power consumption level.

Conventional power management systems and algorithms may produce adequate performance to power ratios in a majority of cases. However, in some instances, such as in the case of a single threaded or a partially multithreaded processor workload, a drop in performance to power ratios may result. Thus, a need may exist for methods of improving power management system performance based on varying processor workloads.

### SUMMARY

The following presents a general summary of several aspects of the disclosure in order to provide a basic understanding of at least some aspects of the disclosure. This summary is not an extensive overview of the disclosure. It is not intended to identify key or critical elements of the disclosure or to delineate the scope of the claims. The following summary merely presents some concepts of the disclosure in a general form as a prelude to the more detailed description that follows.

An aspect of the present disclosure is a method for dynamically adjusting performance states of a processor including executing a workload associated with a workload mode. The method also includes determining a primary processor thread among all processor threads executing the workload. The method further includes calculating and setting a performance state (P state) of the processor based on the workload mode.

Another aspect of the present disclosure is a method for configuring performance states of a processor including determining if a current thread is a primary thread among all processor threads associated with a workload executable by the processor. The method also includes determining an existing performance state (P state) and a highest P state for all processor threads associated with the workload. The method includes setting the highest P state for all processor threads associated with the workload when the current thread is the primary thread. The method further includes setting the existing P state of the processor for all processor threads associated with the workload when the current thread is not the primary processor thread.

Yet another aspect of the present disclosure provides for an information handling system (IHS) including a processor, a peripheral device coupled to the processor and a basic input output system (BIOS) executable by the processor. The IHS also includes a performance adjustment module communicatively coupled to the BIOS, the module configured to determine a primary thread among all processor threads associated with a workload executable by the processor and wherein the module is further configured to set a performance state (P state) among all processor threads associated with the workload based on a workload mode.

### BRIEF DESCRIPTION OF THE DRAWINGS

For detailed understanding of the present disclosure, references should be made to the following detailed description of the several aspects, taken in conjunction with the accompanying drawings, in which like elements have been given like numerals and wherein:

FIG. 1 represents an information handling system (IHS) in accordance with one aspect of the present disclosure;

FIG. 2 represents system management mode (SMM) operations within a power management system;

FIG. 3 provides a flowchart of method steps in determining a processor workload;

FIG. 4 provides a flowchart of method steps for adjusting performance of a processor based on varying processor workloads in a conventional power management system; and

FIG. 5 provides a flowchart of method steps for adjusting performance of a processor based on varying processor workloads in an improved power management system.

### DETAILED DESCRIPTION

Before the present systems and methods are described, it is to be understood that this disclosure is not limited to the particular systems and methods described, as such may vary. Also, the present disclosure is not limited in its application to the details of construction, arrangement or order of components and/or steps set forth in the following description or illustrated in the figures. Thus, the disclosure is capable of other aspects, embodiments or implementations or being carried out/practiced in various other ways.

One of ordinary skill in the art should understand that the terminology used herein is for the purpose of describing possible aspects, embodiments and/or implementations only, and is not intended to limit the scope of the present disclosure which will be limited only by the appended claims. Further, use of terms such as “including”, “comprising”, “having”, “containing”, “involving”, “consisting”, and variations thereof are meant to encompass the listed thereafter and equivalents thereof as well as additional items.

It must also be noted that as used herein and in the appended claims, the singular forms “a,” “and,” and “the” may include plural referents unless the context clearly dictates otherwise. Thus, for example, reference to “a processor” refers to one or several processors and reference to “a method of adjusting” includes reference to equivalent steps and methods known to those skilled in the art, and so forth.

For purposes of this disclosure, an embodiment of an Information Handling System (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

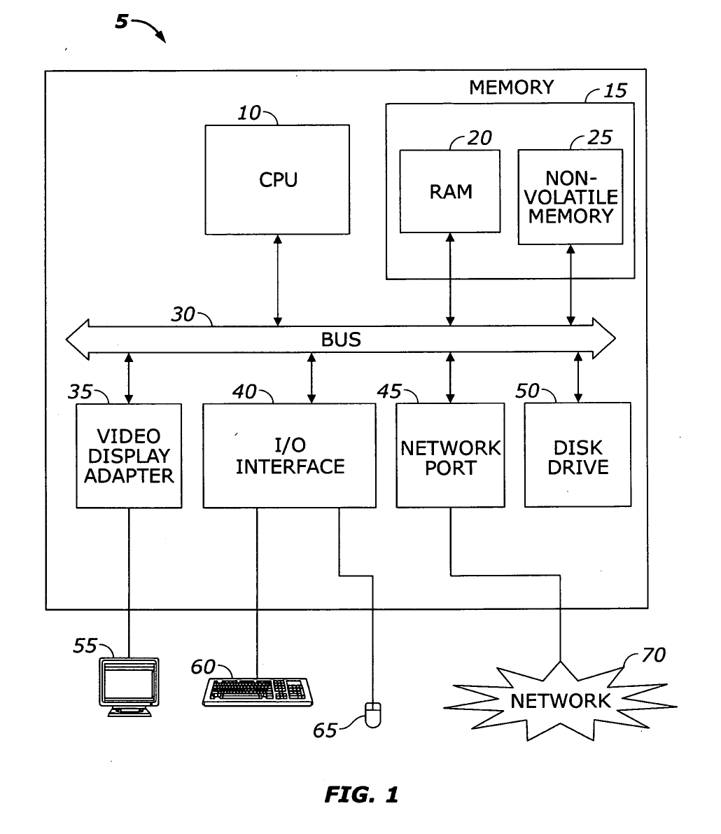

FIG. 1 illustrates one possible implementation of an IHS 5 comprising a CPU 10. It should be understood that the present disclosure has applicability to IHSs as broadly described above, and is not intended to be limited to the IHS 5 as specifically described. The CPU 10 may comprise a processor, a microprocessor, minicomputer, or any other suitable device, including combinations and/or a plurality thereof, for executing programmed instructions. The CPU 10 may be in data communication over a local interface bus 30 with components including memory 15 and input/output interfaces 40. The memory 15, as illustrated, may include non-volatile memory 25. The non-volatile memory 25 may include, but is not limited to, firmware flash memory, non-volatile random access memory (NVRAM), and electrically erasable programmable read-only memory (EEPROM). The non-volatile memory 25 may contain a firmware program (not shown) which may contain programming and/or executable instructions required to control a keyboard 60, mouse 65, video display 55 and/or other input/output devices not shown here. This type of firmware may be known as a basic/input output system (BIOS). The memory may also comprise random access memory (RAM) 20. The operating system and application programs (e.g., graphical user interfaces) may be loaded into the RAM 20 for execution.

The IHS 5 may be implemented with a network port 45 to permit communication over a network 70 such as a local area network (LAN) or a wide area network (WAN), such as the Internet. As understood by those skilled in the art, IHS 5 implementations may also include an assortment of ports and interfaces for different peripherals and components, such as video display adapters 35, disk drives port 50, and input/output interfaces 40 (e.g., keyboard 60, mouse 65).

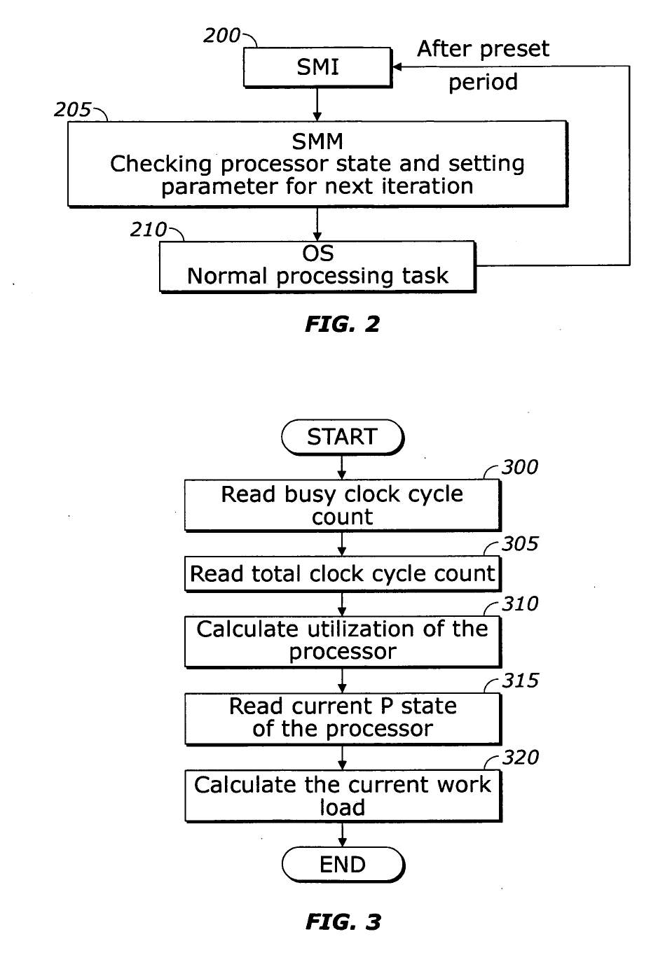

FIG. 2 illustrates a system management mode (SMM) operating procedure in a conventional power management system. System Management Mode (SMM) is an operating mode in which all normal execution of applications, including the operating system (OS), is suspended and separate software (e.g., firmware, hardware-assisted debugger, etc.) may be executed in a specialized mode. During the operation of a conventional power management system, such as the Dell active power controller (DAPC) system, for example, an SMM may take over the processing function of the processor (e.g., central processing unit (CPU)) from the OS through a hardware interrupt, such as a system management interrupt (SMI).

As shown in FIG. 2, after an SMI 200 occurs, the processor may enter an SMM whereby the BIOS (not shown) makes an evaluation of a processor workload, also referred to herein as a workload. The BIOS may also evaluate and establish a new set of working parameters in step 205. Examples of such working parameters include, but are not limited to, the processor clock frequency and working voltage. Taking a fully multithreaded processor workload as an example, the BIOS may investigate current utilization of each processor thread as well as overall utilization of the processor to set a target processor clock frequency. A target processor clock frequency may be set in a manner such that overall utilization of the processor may be increased in a subsequent iteration. Thus, the performance to power ratio may be kept at or above a satisfactory level. After adapting to new working parameters, the processor may quit operation under the SMM and the processor's processing function may be handed back to the OS where normal programs may continue in step 210.

In accordance with the Advanced Configuration and Power Interface (ACPI) specification, the new set of working parameters may be set by exerting a target performance state (P state) of the processor which results in an optimum processing speed. During an operation of a processor, P state represents a core ratio of the processor, or in other words, the clock frequency of the processor. A processor may work under one of several P states ranging from P0 to Pn. In some implementations, P0 may be considered the highest P state which presents the highest processor clock frequency at which a processor can typically work. With P0 being the highest, P1 to Pn are successively lower P states, and in some implementations, n is no greater than 16. In general, a higher processor P state or a higher processor clock frequency may execute more processor workloads, thus indicative of increased performance, than any successive lower processor P state or a lower processor clock frequency at a given period.

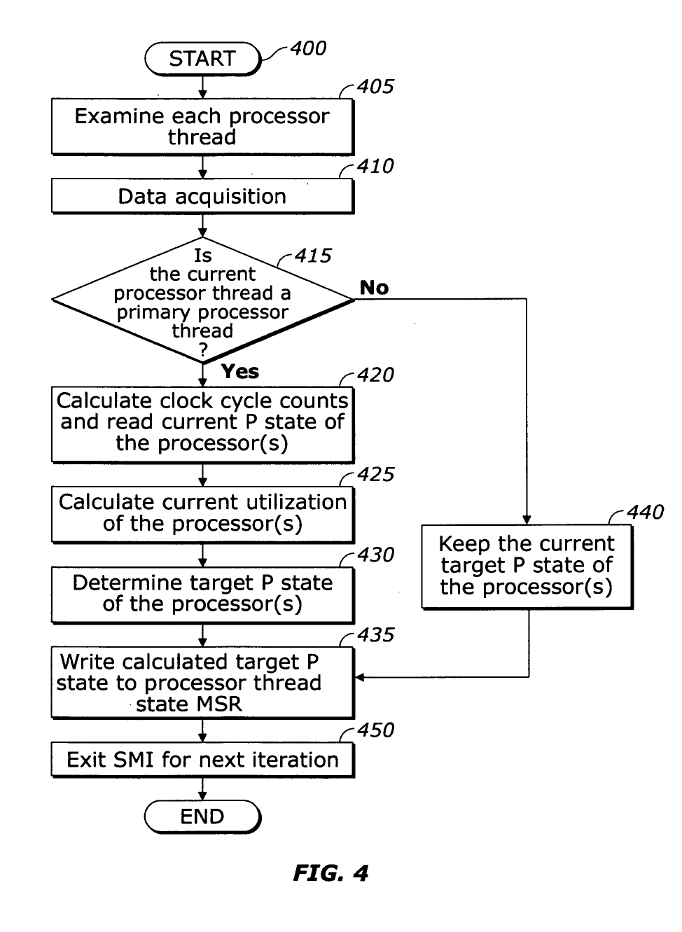

FIG. 3 provides a flowchart of method steps in determining a processor workload. A processor workload may be the product of quantities R and U, wherein R refers to a P state of the processor and U refers to a concurrent utilization of the processor. A utilization of the processor may serve as an indicator of operating efficiency of the processor. A higher utilization of the processor may typically indicate that power resources of a processor may be utilized more efficiently than a lower utilization of the processor. In order to make full use of a power resource assigned to the processor, a target utilization of the processor may typically be set as optimal as 100%. For example, in a processor containing 8 processor threads, 100% utilization of the processor may occur when all 8 processor threads are active. As such, a target P state of the processor for the most efficient execution of the current workload may be calculated when the current workload is determined.

During a specified time lapse, a counter of the busy clock cycles of a processor (e.g., C0_Mcnt) may be read from a corresponding busy clock cycle register in step 300. The C0_Mcnt register counts C0_Mcnt during a period when a processor is in a C0 power state, a processor power state particularly defined as an operating state in accordance with the ACPI specification. In the meantime, total clock cycles of the processor (TSC) during the same specified time lapse may be read from a corresponding total clock cycle register in step 305, whereby the register counts TSC. A ratio of busy clock cycles to total clock cycles may indicate a current utilization of the processor defined by a ratio of a time lapse of the processor when it is active to an entire time lapse of the processor during the same time domain. As such, utilizations (U) of the processor may be determined by the equation, U=C0_Mcnt/TSC in step 310. Then, a current P state of the processor may be directly read from a corresponding system register in step 315. Having acquired all the above data or parameters, a current workload may be determined by the equation, workload=R*U, in step 320.

As used herein, a “processor thread” may refer to an architectural state within a processor that tracks execution of a software program task. The processor thread shall be distinguished from what is known as a program thread or thread of execution, which may provide a way for a program to split itself into two or more simultaneously running tasks.

Generally, workloads executed by a processor may be characterized by a workload mode indicating a number of processor threads required to execute the workload. A fully multithreaded workload mode may refer to a workload requiring all processor threads to be active at the same time during the operation of the processor. Alternatively, a partially multithreaded workload mode may refer to a workload requiring some of the processor threads to be active at the same time during the operation of the processor. A single threaded workload mode may refer to a workload only requiring one of all processor threads to be active during the operation of the processor.

In an exemplary implementation, an entire processor workload executing time of the processor C0_Mcnt may be determined, such as by the equation: C0_Mcnt=ΣC0_Mcnti, whereby ΣC0_Mcnti represents a sum of workload executing time of all processor threads. Therefore, in the event of a fully multithreaded workload mode, a processor utilization may be calculated by the equation U=ΣC0_Mcnti/ΣTSCi, whereby ΣTSCi represents a sum of specified timeslots for each processor thread. Since the length of each timeslot for each processor thread may be fixed, the above equation may be further deducted as U=ΣC0_Mcnti/(TSCi*n)=ΣUi/n, wherein TSCi may refer to a counter of clock cycle of each timeslot, ΣUi may refer to a sum of processor thread utilization for each processor thread, and n may refer to a number of timeslots divided in a given time domain. Therefore, in the event of a fully multithreaded mode, the processor utilization may be equal to the average processor thread utilization.

In a fully multithreaded workload mode, the utilization of all processor threads may typically be kept at similar levels. In implementing a conventional power management algorithm, the BIOS may be based on the above demonstration to determine a target P state (Rt) of the processor. Further, the BIOS may further change or update the Rt of each processor thread during a SMI iteration for achieving an optimal processor utilization in a fully multithreaded mode scenario.

FIG. 4 provides a flowchart of method steps for adjusting the performance states of processor(s) based on different processor workloads in a conventional power management algorithm. The BIOS may examine each of several processor threads handled by the processor(s) in step 405. Data such as counts of busy clock cycles when a processor thread is active (e.g., C0_Mcnt) and counts of total clock cycles included during an entire timeslot (e.g., TSC) for such processor thread may be acquired in the step 410. The C0_Mcnt and TSC counts for each processor thread may be read from their respective registers.

A primary thread (i.e., processor thread) is then designated among all processor threads associated with a workload in step 415. A conventional power management system may set a target P state of the processor only once when a current thread (i.e., processor thread) is the primary processor thread and keep the same target P state of the processor during the same SMI. Doing so may ensure only one target P state is kept for all processor threads to avoid any inconsistency or conflict of inputs of the target P state of the processor threads. If it is determined that a current processor thread is not the primary processor thread, the BIOS may keep an existing P state of the processor as the target P state for all processor threads in step 440. Then, the BIOS may then update the target P state of the processor to the primary processor thread (e.g., processor thread state machine state register (MSR)) in step 435. On the other hand, if the current processor thread is determined to be the primary processor thread, the BIOS may acquire data such as total count of clock cycles when a processor is active (e.g., C0_McntP) and total count of clock cycles included during an entire time domain (e.g., TSCP) for the processor in step 420. C0_McntP may be calculated by adding C0_Mcnt for each processor thread and TSCP may be read directly from the TSC register. The BIOS may also read a current P state of the processor directly from a corresponding register in the step 420. Then, the BIOS may further calculate a current utilization of the processor in step 425 and determine a target P state of the processor in step 430. Further still, the BIOS may update the latest target P state of the processor to the primary processor thread (e.g., MSR) in step 435 and prepare for the next iteration in step 450.

As an assumption, the processor of a conventional power management system may be set to execute a workload in a fully multithreaded mode. When a system operates in a partially-multithreaded or single-threaded mode, however, the algorithm applied in a conventional power management system may not be suitable for determining a target P state of the processor. In the event of a partially-multithreaded or single-threaded mode, one or more processor threads may be expected to be idle during a given time domain. In some instances, utilizations of idle processor threads may be expected to be zero. In general power management systems, a target processor performance state (Rt) may be determined by the equation Rt=(Rc*Uc)/Ut, whereby Uc refers to a current P state of the processor, which may be equal to the average current utilization of all processor threads. Since the utilizations of the idle processor threads may be expected to be zero, the average current utilization of all processor threads may not accurately reflect the current utilization of each processor thread. As a result, the target P state of the processor may not be suited for executing processor workloads assigned to each processor thread. For example, an active processor thread with the lowest processor thread utilization may require a P state higher than the target P state calculated based on the conventional power management algorithm. When a target P state of the processor is insufficient for executing a workload assigned to a processor thread, the overall system may experience a decline in executing future processor workloads. Such a decline may eventually impact the performance per watt ratio of an IHS and further incur undesirable results such as poor power efficiency.

An idle processor thread may be wasting power resources of the processor since the idle processor thread may be assigned a target P state for a non-existing processor workload. Wasted power may be determined by an equation P=CVf²/2, wherein C refers to a constant, V refers to a supply voltage, and f refers to a P state of the processor assigned to the idle processor thread. In some instances, power resources of a processor may be mistakenly distributed to an idle processor thread and wasted rather than being applied to active processor threads for executing the processor workload in a conventional power management system.

In order to overcome a waste of resources, an improved power management system and algorithm may determine if a processor is executing a workload in a fully multithreaded mode, a partially multithreaded mode, or a single thread mode before assigning the target P states to each processor thread.

As demonstrated earlier, a partially multithreaded mode and/or a single thread mode may suggest one or more processor threads may be idle and as such may have zero utilization since no workload may be performed on the idle processor thread. Thus, a significant difference between a maximum current processor thread utilization (Umax) and a minimum current processor thread utilization (Umin) may be expected in event of a partially multithreaded mode or a single thread mode. To the contrary, in the case of a fully multithreaded mode, as demonstrated earlier, the difference between UMax and UMin may be relatively small since all processor threads may be required to stay active for executing a fully multithreaded workload.

The improved power management system as disclosed herein may establish a threshold percentage of utilization to be compared to the difference between Umax and Umin. As used herein, threshold percentage of utilization may be used interchangeably with threshold percentage of processor thread utilization. In the case of a partially multithreaded mode or a single threaded mode, Umin may be zero. Generally, the threshold percentage of utilization establishes a boundary by which a mode is designated as either fully multithreaded or partially multithreaded/single threaded. If the difference between Umax and Umin lies below the threshold percentage of utilization, it may be designated as a fully multithreaded mode. If the difference between Umax and Umin is greater than the threshold percentage of utilization, a workload may be designated as a partially multithreaded mode or a single threaded mode.

In the event of a partially multithreaded mode or a single threaded mode, in order to ensure proper execution of a processor thread, a maximum target P state (Pmax) of the processor thread may be set as the target P state of the processor.

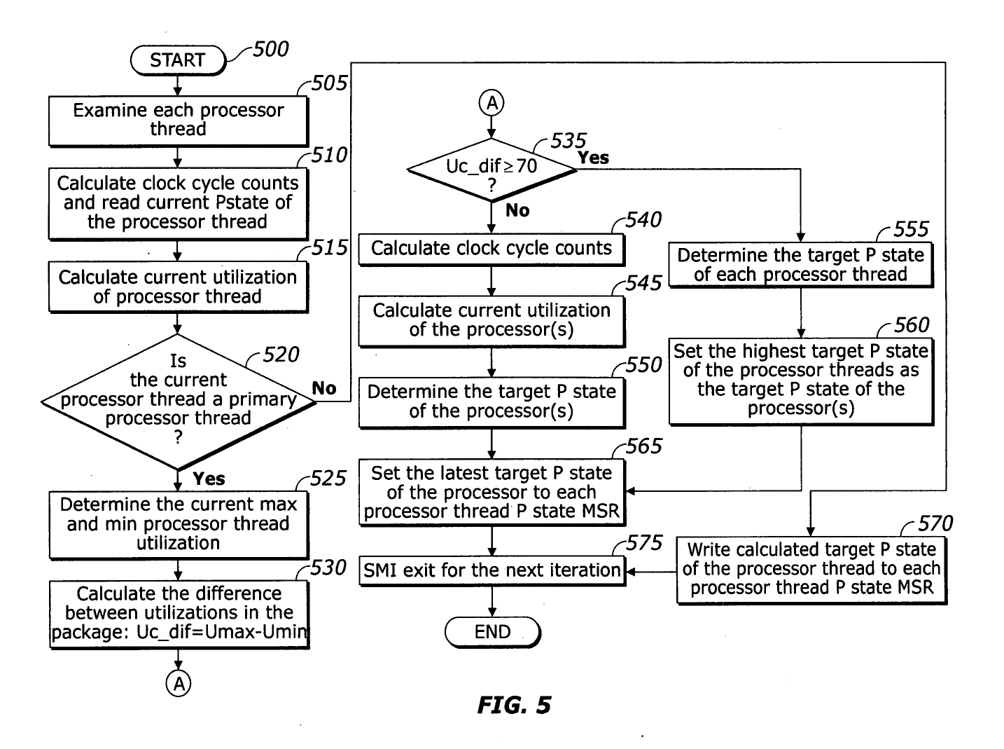

FIG. 5 provides a flowchart of method steps for adjusting performance of a processor based on types of workloads in accordance with one aspect of present disclosure. Similar to a conventional power management system, an improved power management system algorithm starts with an SMI iteration in step 500 by examining each processor thread associated with the processor workload in step 505. Data such as counts of busy clock cycles when a current processor thread is active (e.g., C0_Mcntc) and counts of total clock cycles included during an entire timeslot (TSCc) for such processor thread may be acquired in step 510. The C0_Mcnt counts and TSC counts for each processor thread may be read from their respective registers. A current utilization of each processor thread may be determined in step 515, such as by the equation, Uci=C0_Mcntci/TSCci, wherein Uci refers to a current utilization of each processor thread. Further, C0_Mcntci refers to counts of busy clock cycles when a current processor thread is active, and TSCci refers to counts of total clock cycles included during a timeslot for each processor thread. Then, it is determined if a current processor thread is assigned to be the primary processor thread in step 520. If the current processor thread is assigned to be the primary thread, the BIOS may further evaluate the current utilization of each processor thread and determine a maximum current processor thread utilization (Umax) and a minimum current processor thread utilization (Umin) among all current utilizations of the processor threads in step 525. The difference between Umax and Umin is then determined in step 530. Next, in step 535, it is determined whether the difference between Umax and Umin is greater than a threshold percentage of processor thread utilization. If the difference between Umax and Umin is greater than the threshold percentage of processor thread utilization, an occurrence of a partially multithreaded mode or a single threaded mode may be designated for the workload. The threshold percentage of processor thread utilization, in accordance with one aspect of the present disclosure, may be set at approximately 70%.

Continuing with FIG. 5, in the event of a partially multithreaded mode or a single threaded mode, a target P state of each processor thread may be determined in step 555. The highest P state of the processor threads may be determined among all target P states of the processor threads. The highest P state of the processor threads may be further set as a target P state of the processor in step 560. Further still, the latest target P state of the processor may be set to each processor thread in step 565. The BIOS may then quit the current SMI iteration and prepare for a next SMI iteration in step 575.

In the event that the difference between Umax and Umin is less than the threshold percentage of processor thread utilization, a processor workload may be recognized as a fully multithreaded mode. The BIOS may acquire data, such as counts of clock cycles, for example, when a processor is active (e.g., C0_McntP) and counts of clock cycles during an entire time domain (e.g., TSCP) for the processor in step 540. C0_McntP may be calculated by adding C0_Mcnt for each processor thread. TSCP may be read directly from the TSC register. The BIOS may read a current P state of the processor directly from a corresponding register in step 540. The BIOS may then further calculate a current utilization of the processor in step 545 and determine a target P state of the processor in step 550. The latest target processor performance state may be set to each processor thread (e.g., processor thread state machine state register (MSR)) in step 565. The BIOS may then quit the current SMI iteration and prepare for a next SMI iteration in step 575.

When a current processor thread is not the primary processor thread, the BIOS may maintain an existing P state of the processor when the current processor thread is the primary processor thread during the same SMI for all processor threads in step 570. The existing target P state may be either the aforementioned highest P state of the processor threads or the aforementioned target P state of the processor depending on whether the difference between Umax and Umin is greater than or less than the threshold percentage of processor thread utilization. Then, the latest target P state of the processor may be set to each processor thread in step 565. The BIOS may quit the current SMI iteration and prepare for a next SMI iteration in step 575.

Based on the improved power management system algorithm disclosed herein, the P state, and consequently the performance of the processor, may be modified dynamically without any necessity of requiring any input from the user of the IHS. Thus, the improved power management system may provide enhanced performance and/or convenience to the user as compared to the conventional power management system.

Furthermore, methods of the present disclosure, detailed description and claims may be presented in terms of logic, modules (e.g., performance adjustment module), software or software implemented aspects typically encoded on a variety of media or medium including, but not limited to, computer-readable medium/media, machine-readable medium/media, program storage medium/media or computer program product. Such media, having computer-executable instructions, may be handled, read, sensed and/or interpreted by a computer. Generally, computer-executable instructions, such as program modules, may include routines, programs, objects, components, data structures, and the like, which perform particular tasks, carry out particular methods or implement particular abstract data types. Those skilled in the art will appreciate that such media may take various forms such as cards, tapes, magnetic disks (e.g., floppy disk or hard drive) and optical disks (e.g., compact disk read only memory (“CD-ROM”) or digital versatile disc (“DVD”)). It should be understood that the given implementations are illustrative only and shall not limit the present disclosure.

Although the present disclosure has been described with reference to particular examples, embodiments and/or implementations, those skilled in the art will recognize that modifications and variations may be made without departing from the spirit and scope of the claimed subject matter. Such changes in form and detail, including use of equivalent functional and/or structural substitutes for elements described herein, fall within the scope of the appended claims and are intended to be covered by this disclosure.

What is claimed is:

1. A method for dynamically adjusting performance states of a processor, the method comprising:
executing a workload associated with a workload mode;
determining a primary thread among all processor threads executing the workload; and
calculating and setting a performance state (P state) of the processor based on the workload mode.

2. The method of claim 1, wherein the workload mode is a single threaded mode.

3. The method of claim 1, wherein the workload mode a partially multithreaded mode.

4. The method of claim 1, wherein the workload mode is a fully multithreaded mode.

5. The method of claim 1, wherein calculating and setting the performance P state comprises setting a target P state of the processor if the workload mode is a partially multithreaded mode.

6. The method of claim 5, wherein setting a target P state of the processor comprises setting the target P state of each processor thread associated with the workload.

7. The method of claim 1, wherein calculating and setting the performance P state comprises setting a highest P state of all processor threads if the workload mode is a fully multithreaded mode.

8. The method of claim 1, wherein calculating and setting the performance P state comprises setting an existing P state calculated by the primary thread for all processor threads if a current thread is not the primary thread.

9. The method of claim 1, wherein calculating and setting the performance P state comprises setting a highest target P state of all processor threads as a second target P state of the processor if the workload mode is a single threaded mode.

10. The method of claim 1 further comprising:
setting a target utilization for the current thread associated with the workload.

11. A method for configuring performance states of a processor, the method comprising:
determining if a current thread is a primary thread among all processor threads associated with a workload executable by the processor;
determining an existing performance state (P state) and a highest P state for all processor threads associated with the workload;
setting the highest P state for all processor threads associated with the workload when the current thread is the primary thread; and
setting the existing P state for all processor threads associated with the workload when the current thread is not the primary processor thread.

12. The method of claim 11, wherein determining the existing P state and the highest P state comprises determining a target P state for each processor thread associated with the workload.

13. The method of claim 12, wherein determining the target P state for each processor thread associated with the workload comprises setting a target utilization of the current thread of the workload.

14. An information handling system (IHS) comprising:
a processor;
a peripheral device coupled to the processor;
a basic input output system (BIOS) executable by the processor; and
a performance adjustment module incorporated within the IHS, wherein the performance adjustment module is communicatively coupled to the BIOS, the module configured to determine a primary thread among all processor threads associated with a workload executable by the processor and wherein the module is further configured to set a performance state (P state) among all processor threads associated with the workload based on a workload mode.

15. The system of claim 14, wherein the performance adjustment module is further configured to set a target P state among all processor threads associated with the workload when a current thread is the primary thread and the workload is a partially multithreaded mode.

16. The system of claim 14, wherein the performance adjustment module is further configured to set a highest P state among all processor threads associated with the workload when a current thread is the primary thread and the workload is a fully multithreaded mode.

17. The system of claim 14, wherein the performance adjustment module is further configured to set an existing P state of the processor among all processor threads associated with the workload when a current thread is not the primary thread.

18. The system of claim 14, wherein the performance adjustment module is further configured to determine whether a current workload mode is a first mode or a second mode, wherein the first mode is determined when a difference between a maximum current processor thread utilization (Umax) and a minimum current processor thread utilization (Umin) is greater than a threshold percentage of processor thread utilization and the second mode is determined when the difference between Umax and Umin is less than the threshold percentage of processor thread utilization.

19. The system of claim 14, wherein the performance adjustment module is further configured to place the workload into a single threaded mode, wherein the single threaded mode is determined when the difference between Umax and Umin is greater than a threshold percentage of processor thread utilization.

20. The system of claim 19, wherein the performance adjustment module is further configured to set a highest target P state among all processor threads associated with the workload when a current thread is a primary thread and the workload mode is a single threaded mode.
